(19) United States
(12) Patent Application Publication
(10) Pub. No.: US 2026/0064568 A1
(43) Pub. Date: Mar. 5, 2026

(54) SYSTEM AND METHOD FOR TEST CASE GENERATION

(71) Applicant: Torc Robotics, Inc., Blacksburg, VA (US)

(72) Inventors: Mustafa Yasin Kara, Blacksburg, VA (US); Byron Sullivan, Buda, TX (US); Ertugrul Baris Ondes, Blacksburg, VA (US)

(73) Assignee: Torc Robotics, Inc., (omitted)

(21) Appl. No.: 18/823,938

(22) Filed: Sep. 4, 2024

(51) Int. Cl. G06F 11/36

(52) U.S. Cl. CPC G06F 11/3684; G06F 11/3698

(57) ABSTRACT

A system for test case generation is provided. The system includes a user interface configured to receive as input data relating to an autonomous vehicle, test objectives for testing of the autonomous vehicle, and expected results of the testing of the autonomous vehicle. The system includes a database storing the data input into the user interface and data relating to previously derived test cases. The system includes a language learning model (LLM) unit trained on the previously derived test cases and configured to generate a test case based on the input data. The system includes a processing device that executes the LLM unit to analyze the autonomous vehicle, the test objectives for testing of the autonomous vehicle, and the expected results of the testing of the autonomous vehicle, and generates with the LLM unit the test case that meets the test objectives for testing of the autonomous vehicle.

### TECHNICAL FIELD

The field of the disclosure relates to test case generation and, in particular, to a system for generating test cases for autonomous vehicles using artificial intelligence based on baseline requirements.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

During programming of the operational systems of the autonomous vehicle and before the autonomous vehicle is permitted to operate on public roads, testing of the operational systems (and subsystems) is necessary to ensure compliance. Conventionally, test cases are prepared manually by programmers based on certain test objectives. However, such preparation process can be time consuming and may not accurately test all intended test objectives. As such, several iterations with modifications may be necessary until the test objectives are achieved. With the growth of autonomous vehicle technology in recent years, conventional test case preparation fails to provide a scalable option.

Accordingly, there exists a need for a system and a method for test case generation that can efficiently generate test cases that meet all test objectives for testing of autonomous vehicles in an optimal manner. These and other needs are met by the exemplary system for test case generation discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for test case generation is provided. The system includes a user interface configured to receive as input data relating to an autonomous vehicle, test objectives for testing of the autonomous vehicle, and expected results of the testing of the autonomous vehicle. The system includes a database configured to electronically store the data input into the user interface and data relating to previously derived test cases. The system includes a language learning model (LLM) unit trained on the previously derived test cases and configured to generate a test case based on the input data. The system includes a processing device in communication with the user interface, the database, and the LLM unit. The processing device is configured to execute instructions stored in a memory to perform operations that include executing the LLM unit to analyze the autonomous vehicle, the test objectives for testing of the autonomous vehicle, and the expected results of the testing of the autonomous vehicle. The operations include generating with the LLM unit the test case that meets the test objectives for testing of the autonomous vehicle.

The test objectives can include preconditions for the testing of the autonomous vehicle. The test objectives are intended to prove performance of the autonomous vehicle against a set of requirements. In some embodiments, the set of requirements can include, e.g., system requirements, subsystem requirements, software requirements, hardware requirements, technical safety requirements, functional safety requirements, combinations thereof, or the like, associated with the autonomous vehicle.

The test objectives can include a base scenario, preconditions, and expected post-conditions. The LLM unit is configured to generate the test case in a form of software executable by a processing device of the autonomous vehicle. The expected results include at least one action to be taken by the autonomous vehicle in response to the test objectives. In some embodiments, the at least one action can include, e.g., an acceleration of the autonomous vehicle, a deceleration of the autonomous vehicle, a complete stop of the autonomous vehicle, a lane change of the autonomous vehicle, a manipulation in a behavior of the autonomous vehicle, a manipulation in a component of the autonomous vehicle, or a manipulation of a subsystem of the autonomous vehicle.

In some embodiments, the system can be used to test static tasks, dynamic tasks, or combinations thereof. The static tasks can include, e.g., a Mission Control (MC) System Connection Check, a Mission Control Mission Acceptance Check, a MC Departure request check, a MC Safety check., Sensor Calibration, Map Loading and Localization, System Diagnostics, Path Planning with MC, V2X Communication Setup, Pre-trip safety checks, combinations thereof, or the like. The dynamic tasks can include, e.g., Adaptive Cruise Control (ACC) tasks, Vulnerable Road User Detection, Vehicle Control Subsystem feedback, Perception Subsystem feedback, Localization and Mapping, Real-time environment perception, path planning and prediction, decision making, obstacle avoidance, traffic signal and sign recognition, Vehicle to Everything Communication, Human Machine Interaction, Weather adaptation, data logging and learning, combinations thereof, or the like.

The operations can include generating with the LLM unit the test case that meets the expected results of the testing of the autonomous vehicle. The user interface can be configured to receive as input data relating to environmental conditions during testing of the autonomous vehicle. The operations can include generating recommendations for modification or supplementing of the test case to meet the test objectives. The operations can include generating recommendations for safety requirements for inclusion in the test case. The test case can include testing guidelines for testing of a specific characteristic of the autonomous vehicle. The test case can include testing guidelines for testing of an action taken by the autonomous vehicle in response to predetermined input.

In another aspect, an exemplary computer-implemented method for test case generation is provided. The method includes receiving as input at a user interface data relating to an autonomous vehicle, test objectives for testing of the autonomous vehicle, and expected results of the testing of the autonomous vehicle. The method includes electronically storing, in a database the data input into the user interface and data relating to previously derived cases. The method includes training a language learning model (LLM) unit on the previously derived test cases. The method includes executing instructions stored in a memory with a processing device in communication with the user interface, the database and the LLM unit to perform operations that include executing the LLM unit to analyze the autonomous vehicle, the test objectives for testing of the autonomous vehicle, and the expected results of the testing of the autonomous vehicle. The operations include generating with the LLM unit the test case that meets the test objectives for testing of the autonomous vehicle.

The method comprises generating with the LLM unit the test case in a form of software executable by a processing device of the autonomous vehicle. The expected results can include at least one action to be taken by the autonomous vehicle in response to the test objectives. The operations can include generating with the LLM unit the test case that meets the expected results of the testing of the autonomous vehicle. The operations can include generating recommendations for modification or supplementing of the test case to meet the test objectives. The operations can include generating recommendations for safety requirements for inclusion in the test case.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck.

FIG. 2 is a block diagram of the autonomous truck shown in FIG. 1.

FIG. 3 is a block diagram of an example computing system.

FIG. 4 is a block diagram of an exemplary system for test case generation.

FIG. 5 is a flowchart of a method for test case generation.

FIG. 6 is a block diagram of an exemplary system for test case generation.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for test case generation discussed herein can use artificial intelligence and/or machine learning to create test cases according to baseline requirements input into the system. In some embodiments, the system can be voice-based and/or text-based, and testing engineers for the autonomous vehicles can edit and modify test cases generated by the system (if needed). Using artificial intelligence to generate the test cases based on the discussion herein provides a scalable process that can accommodate the ever-growing autonomous vehicle industry. Autonomous vehicles can thereby be tested in an efficient manner before product validation and launch.

Test cases, as discussed herein, refer to a set of preconditions, inputs, and expected results, developed to drive execution of a test item to meet test objectives. The primary test objective is to directly prove that the autonomous vehicle is capable of performing against a given set of requirements. The test case can be an elementary test guideline intended to provide a specific characteristic of a test object. The test case can include an unambiguous identification, a base scenario, preconditions, inputs, expected output/reactions from the autonomous vehicle, and expected post-conditions. The goal of the test cases is therefore to see how the autonomous vehicle reacts and performs based on an established set of preconditions, and whether the reactions and performance of the autonomous vehicle is in-line with the expected reactions and performance.

A variety of baseline inputs or requirements are used by the system to define the necessary behaviors the autonomous vehicle needs to perform consistently to confidently release the autonomous vehicle as a customer or public-facing product. Artificial intelligence in the form of a language learning model (LLM) trained on a preexisting database of derived test cases can be used to generate the new test cases. The trained AI model can be prompted with a set of system requirements and is capable of generating test cases based on context present in the provided system requirements.

The system allows users to input requirements for testing and the system outputs logical scenarios for the test of such requirements in the form of test cases. In some embodiments, the test cases can be in the form of software code usable for testing of the autonomous vehicles. In some embodiments, the test cases can be in the form of guidelines on how software code should be written to achieve and cover the testing requirements. In some embodiments, the system can generate recommendations on additional requirements needed to ensure full operational of the autonomous vehicle. The system therefore parses the input requirements to determine the necessary test steps and coverage items required to adequately prove performance of a given requirements by the autonomous vehicle. The system generates test cases in an efficient and more accurate manner, as compared to conventional methods.

Based on the results of the test case, modifications can be made to the operational system programming of the autonomous vehicle to ensure the reactions and performance of the autonomous vehicle meet the required expectations. Once modifications are made (if needed), the autonomous vehicle can be tested again to ensure the proper reaction and performance is achieved. Multiple iterations of scenarios in test cases can be used before a determination is made whether the autonomous vehicle is considered safe for passage on public roads.

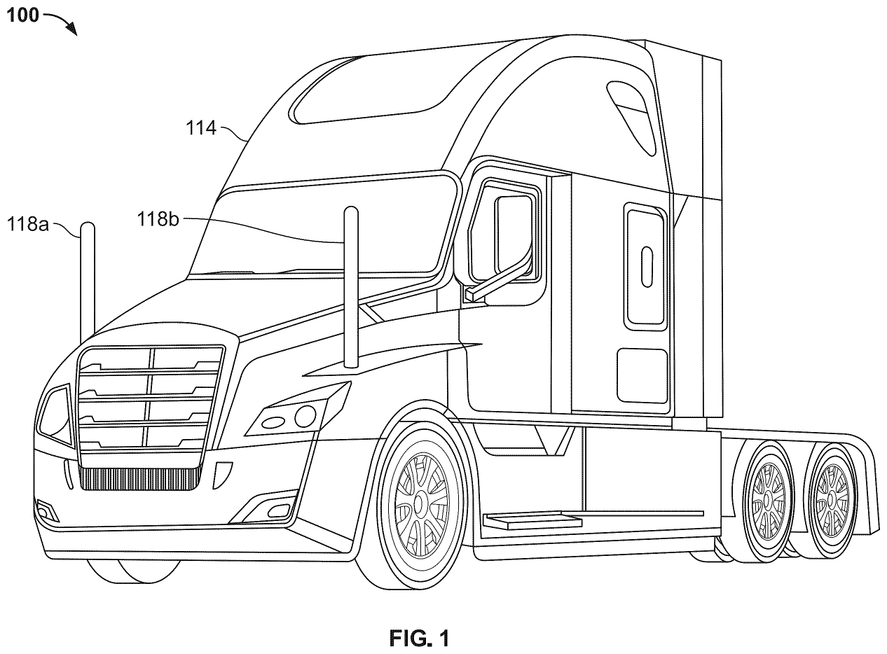

Various embodiments in the present disclosure are described with reference to FIGS. 1-6 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. For example, the vehicle 100 can include one or more antenna 118a, 118b at or near the front of the vehicle 100 with sensors having a field-of-view at the front and/or sides of the vehicle 100.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer. The environmental coverage by the sensors and/or cameras therefore provides data corresponding with the front, rear, sides and corners of the vehicle 100 and the trailer hauled by the vehicle 100.

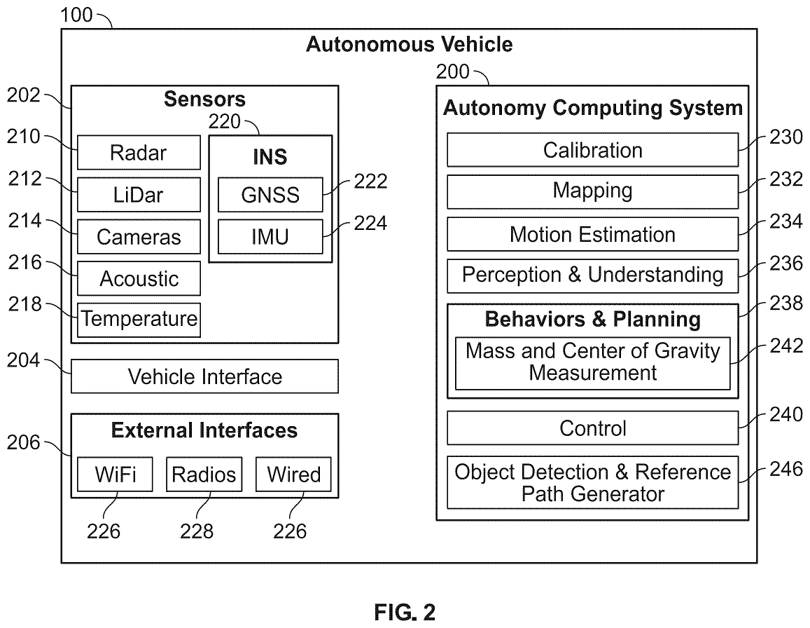

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, cither autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

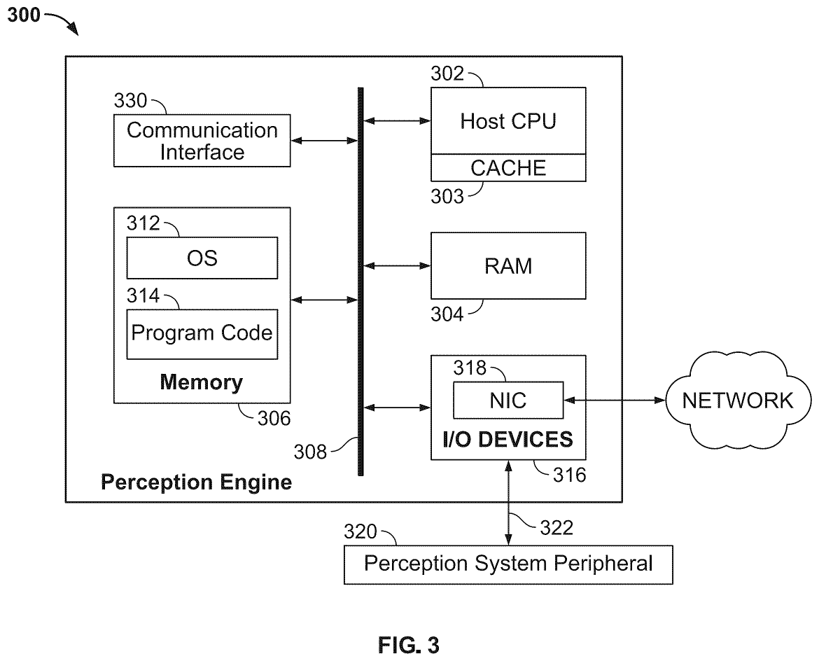

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

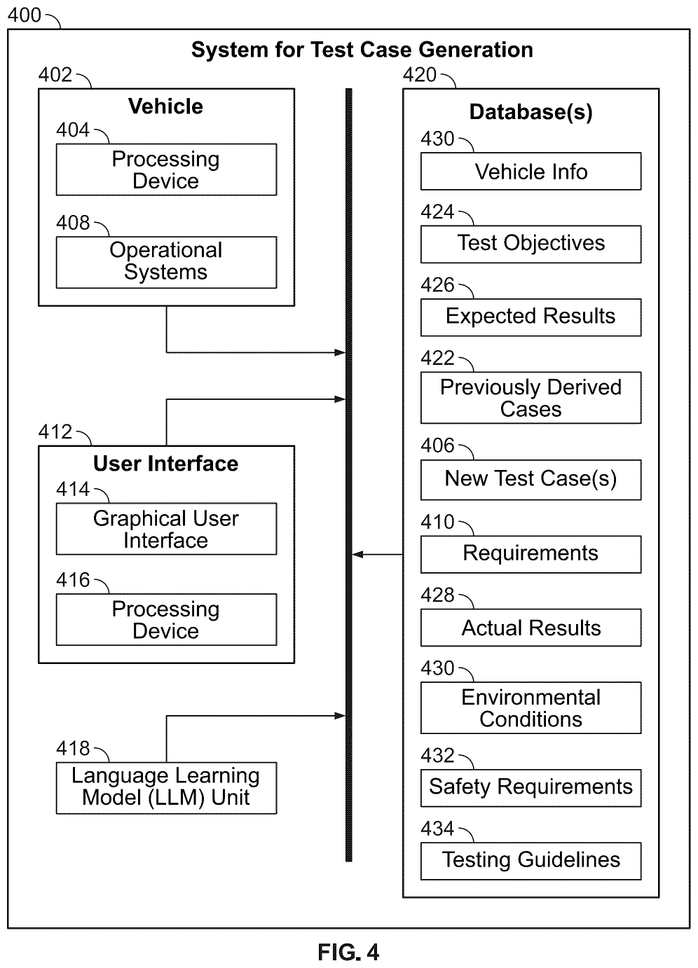

FIG. 4 is a block diagram of an exemplary system 400 for test case generation. The system 400 generally includes one or more vehicles 402 (e.g., autonomous vehicle 100). Each vehicle 402 includes a processing device 404 (e.g., computing system 200, computing system 300, or the like) configured to receive and process data for test cases 406 executed to test operation of the vehicle 402. The test cases 406 are used to determine if one or more of the operational systems 408 (e.g., sensors 202, vehicle interface 204, external interfaces 206, computing system 200, or the like) of the vehicle 402 react and operate as expected (and as needed) based on requirements 410 associated with the test case 406.

The system 400 includes at least one user interface 412 for generating and running the test cases 406. In some embodiments, the user interface 412 can be associated with a central mission control in communication with the vehicle 402. In some embodiments, the user interface 412 can include a graphical user interface (GUI) 414 configured to receive and output/transmit data associated with test case generation. The user interface 412 includes a processing device 416 for processing the input data to generate the test cases 406.

The system includes a language learning model (LLM) unit 418 in communication with the vehicle 402, the user interface 412, and one or more databases 420 (e.g., memory 306). The database 420 is configured to receive and electronically store data. In some embodiments, the database 420 can be stored externally from the vehicle 402 and/or the user interface 412, and the vehicle 402 and/or the user interface 412 can be in communication with the external database 420 for receiving and/or transmitting data associated with the system 400.

The LLM unit 418 is an artificial intelligence and/or machine learning program that receives data from the vehicle 402, the user interface 412 and/or the database 420, and processes the data to output test cases 406. The LLM unit 418 can receive data for previously derived cases 422, e.g., test cases previously prepared and executed to test the vehicle 402, to train operation of the LLM unit 418. The derived cases 422 include software code for testing of various test objectives 424 based on test requirements 410, as well as expected results 426 and actual results 428 of the tests. The more derived cases 422 used to train the LLM unit 418, the more accurate and efficient the generation of new test cases 406 by the LLM unit 418.

In some embodiments, the LLM unit 418 can include the following operations: pre-training, fine-tuning, inference (generation), and evaluation and feedback (optional). The pre-training stage can include data collection, tokenization, neural network training, and learning patterns. For data collection, the LLM unit 418 can initially be trained on massive datasets existing system requirements and test cases. For tokenization, the system requirements can be broken down into smaller units called tokens, which can be words, sub-words, or even individual characters, depending on the model used. These tokens can then be converted into numerical representations that the model can process. For neural network training, the model can be built using a neural network architecture, often a transformer. During pre-training, the model can learn to predict the next token in a sequence, given the preceding tokens. This process involves adjusting millions or billions of parameters within the network to minimize prediction errors. For learning patterns, through training, the LLM unit 418 can learn complex patterns in the system requirements and existing test cases data, such as grammar, syntax, facts, and even some reasoning abilities.

The fine-tuning stage can include domain-specific training, and supervised learning. For domain-specific training, after the initial pre-training, the LLM can be fine-tuned on a smaller, more specific dataset. This helps the model specialize in a particular domain (e.g., test case creation or generation) or improve its performance on certain tasks. For supervised learning, fine-tuning can often involve supervised learning, where the model is trained on specific examples of input-output pairs. This helps the model become more accurate in particular applications. In some embodiments, this can be accomplished using test engineers.

The inference (generation) stage can include input processing, context understanding, context understanding, text generation (test case generation), and output. For input processing, when a user inputs a prompt or a question to create a test case according to the system requirement, the text can be tokenized and passed through the LLM unit 418. The model processes the input based on the patterns it learned during training. For context understanding, the LLM analyzes the input in the context of previously processed tokens, allowing it to maintain coherence and relevance in its response. The model's attention mechanism helps it focus on important parts of the input while generating a response for test case generation. For text generation (test case generation), the LLM predicts and generates the next token in the sequence, continuing this process until it completes the response for the test case generation. The LLM can produce sentences, paragraphs, or even long-form content based on the input and the parameters set by the user (such as maximum length, creativity, or the like). For output, the generated tokens can be converted back into text and presented as the output. This output aims to be contextually relevant, grammatically correct, and aligned with the user's request.

The evaluation and feedback stage can include human feedback, and continuous learning. For human feedback, in some cases, human evaluators (e.g., test engineers) can review the model's outputs, providing feedback that can be used to further refine the model. For continuous learning, although many LLMs do not learn continuously, newer architectures and frameworks are exploring ways to incorporate user feedback and interactions to improve performance over time.

The user interface 412 can be used to receive input of data for generating the test cases 406, and can be in communication with the LLM unit 418 to process the data to generate and output the software/programming for the test cases 406 to the user interface 412. The user interface 412 can receive vehicle information 430 relating to the autonomous vehicle 402, such as expected performance targets of vehicle, known issues in performance with vehicles (to design edge case tests), combinations thereof, or the like.

The user interface 412 can also receive information relating to test objectives 424, e.g., what elements of the operational systems 408 the generated test case 406 is intended to test. The test objectives 424 can include, e.g., a base scenario, preconditions, expected post-conditions, variables, pass/fail criteria, proof of correct functionality, proof of correct functionality of safety, error recognition and error handling mechanisms, proof of correct reaction to configuration data, proof of correct diagnosis of functionality, proof of correct interaction at interfaces, proof of reliability and/or robustness, proof of efficiency and/or performance, proof of usability, proof of correct performance of security mechanisms and robustness against cyber threats, or the like.

The user interface 412 can further receive as input the expected results 426 of the test case 406, e.g., the expected actions or performance by the vehicle 402 in response to being tested for the objectives 424. Such expected results 426 can include, but are not limited to, e.g., acceleration of the vehicle 402, deceleration of the vehicle 402, a complete stop of the vehicle 402, a lane change by the vehicle 402, a manipulation in a behavior of the vehicle 402, a manipulation in a component of the vehicle 402, a manipulation of a subsystem of the vehicle 402, combinations thereof, or the like. In some embodiments, expected results 426 can include, e.g., staying in lane, following the distance stated in the requirements, perceiving the objects, tracking the objects, annotating the objects, lane change initiated and completed, lane change canceled, enter and exit highway completed, or the like.

After being trained by the derived cases 422, the LLM unit 418 is able to receive input data from the system 400 to generate new test cases 406 that meet certain requirements 410. For example, the requirements 410 can involve one or more sets of requirements of operation of the vehicle 402, e.g., system requirements, subsystem requirements, software requirements, hardware requirements, technical safety requirements, functional safety requirements, or the like. The LLM unit 418 therefore takes into account the vehicle information 430, the test objectives 424, the requirements 410, and the expected results 426 to generate new test cases 406 that meet these elements.

In some embodiments, the requirements can include acceleration constraints regarding limits as vehicle approaches a stop sign. For example, the vehicle must begin decelerating with enough distance before the stop sign so that it can achieve a smooth deceleration of no greater than 1 m/ss (i.e., a system requirement). In some embodiments, the requirements can include perception distance of a sensor. For example, LIDAR must be capable of detecting objects at least 200 m away (i.e., a hardware requirement). In some embodiments, the requirements can include a reaction time to an actor swerving into the vehicle's lane must be no greater than 100 ms (i.e., a safety requirement).

In some embodiments, the LLM unit 418 can also receive as input and consider environmental conditions 430 when generating the test case 406. The test case 406 generated by the LLM unit 418 can be in the form of software executable by the processing device 404 of the vehicle 402, such that the vehicle 402 can be tested. In addition to generating the test case 406, the LLM unit 418 can generate safety requirements 432 for performing the test case 406, and/or testing guidelines 434 for how the test case 406 should be executed.

In some embodiments, the safety requirements 432 can be, e.g., the truck must obey road traffic rules and treat other road users with consideration, truck should be cautious in areas with limited visibility and recognize their operational boundaries, truck uses sensors and other technologies to detect hazards and guide themselves through roadways, truck should be able to handle challenging situations like merging, changing lanes, overtaking slower cars, or the like. The truck should be able to deliver the signals from other subsystems in a timely manner to avoid late responses. The sensors should be able to deliver data even though it has been degraded by the weather.

The LLM unit 418 can generate modifications or improvements to existing test cases 406 to improve results that meet the test objectives 424 and assist the vehicle 402 in achieving the expected results 426. The LLM unit 418 can issue recommendations or alerts for existing test cases 406 that may require modifications due to changes in industry requirements and/or standards. As such, the LLM unit 418 both generate new test cases 406 based on input from the user, and also provide recommendations for improving the test objectives 424 to properly test the vehicle 402.

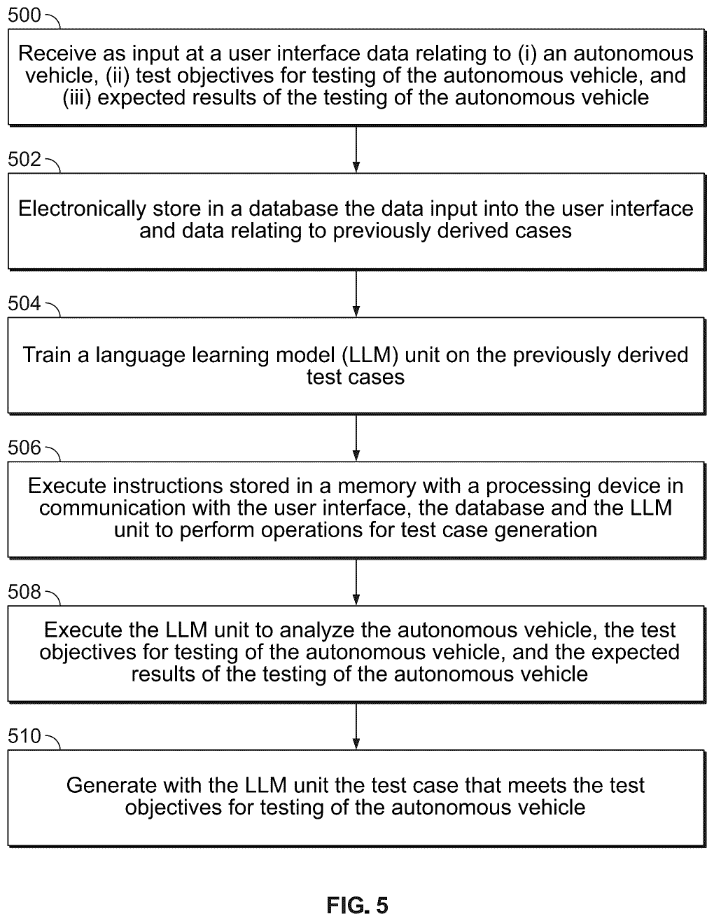

FIG. 5 is a flowchart of a method of test case generation by the exemplary system 400 discussed herein. At 500, a user interface receives as input data relating to an autonomous vehicle, test objectives for testing of the autonomous vehicle, and expected results of the testing of the autonomous vehicle. At 502, the data input into the user interface and data relating to previously derived cases is electronically stored in a database. At 504, an LLM unit is trained on previously derived test cases.

At 506, instructions stored in a memory are executed with a processing device in communication with the user interface, the database, and the LLM unit to perform operations for test case generation. At 508, the LLM unit is executed to analyze the autonomous vehicle, the test objectives for testing of the autonomous vehicle, and the expected results of the testing of the autonomous vehicle. At 510, the test case is generated with the LLM unit that meets the test objectives for testing of the autonomous vehicle.

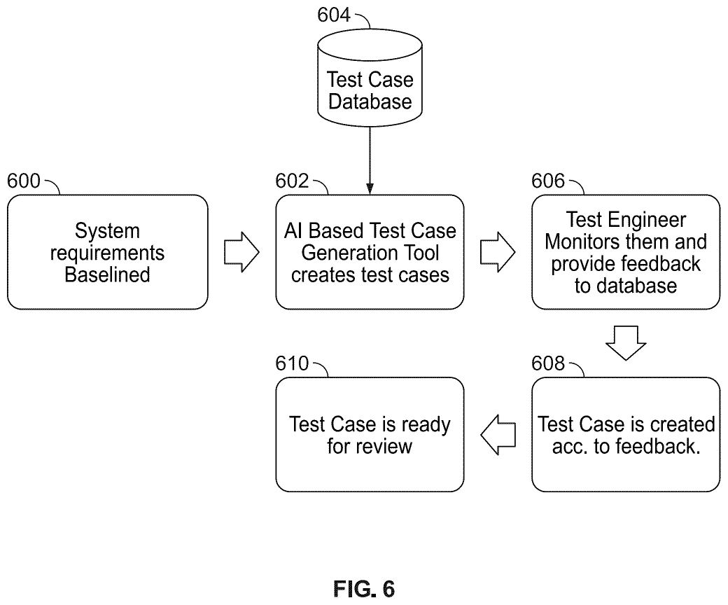

FIG. 6 is a block diagram and flowchart of operation of the exemplary system 400 for test case generation. At 600, baseline system requirements are prepared and input into the LLM unit (at 602), which acts as an artificial intelligence test case generation tool for creating test cases based on the input requirements. At 604, previously derived test cases can be input into the LLM unit as part of training of the artificial intelligence algorithm. At 606, test engineers can monitor the generated test cases and provide feedback to the test case database and the LLM unit to further train the model. At 608, the test case is generated and finalize according to any feedback received from users/engineers. At 610, the test case is ready for review and implementation to test the autonomous vehicle.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for test case generation, comprising:
a user interface configured to receive as input data relating to (i) an autonomous vehicle, (ii) test objectives for testing of the autonomous vehicle, and (iii) expected results of the testing of the autonomous vehicle;
a database configured to electronically store the data input into the user interface and data relating to previously derived test cases;
a language learning model (LLM) unit trained on the previously derived test cases and configured to generate a test case based on the input data; and
a processing device in communication with the user interface, the database, and the LLM unit, wherein the processing device is configured to execute instructions stored in a memory to perform operations comprising:
executing the LLM unit to analyze the autonomous vehicle, the test objectives for testing of the autonomous vehicle, and the expected results of the testing of the autonomous vehicle; and
generating with the LLM unit the test case that meets the test objectives for testing of the autonomous vehicle.

2. The system of claim 1, wherein the test objectives include preconditions for the testing of the autonomous vehicle.

3. The system of claim 1, wherein the test objectives are intended to prove performance of the autonomous vehicle against a set of requirements.

4. The system of claim 3, wherein the set of requirements include at least one of system requirements, subsystem requirements, software requirements, hardware requirements, technical safety requirements, or functional safety requirements, associated with the autonomous vehicle.

5. The system of claim 1, wherein the test objectives include a base scenario, preconditions, and expected post-conditions.

6. The system of claim 1, wherein the LLM unit is configured to generate the test case in a form of software executable by a processing device of the autonomous vehicle.

7. The system of claim 1, wherein the expected results include at least one action to be taken by the autonomous vehicle in response to the test objectives.

8. The system of claim 7, wherein the at least one action includes an acceleration of the autonomous vehicle, a deceleration of the autonomous vehicle, a complete stop of the autonomous vehicle, a lane change of the autonomous vehicle, a manipulation in a behavior of the autonomous vehicle, a manipulation in a component of the autonomous vehicle, or a manipulation of a subsystem of the autonomous vehicle.

9. The system of claim 1, wherein the operations comprise generating with the LLM unit the test case that meets the expected results of the testing of the autonomous vehicle.

10. The system of claim 1, wherein the user interface is configured to receive as input data relating to environmental conditions during testing of the autonomous vehicle.

11. The system of claim 1, wherein the operations comprise generating recommendations for modification or supplementing of the test case to meet the test objectives.

12. The system of claim 1, wherein the operations comprise generating recommendations for safety requirements for inclusion in the test case.

13. The system of claim 1, wherein the test case includes testing guidelines for testing of a specific characteristic of the autonomous vehicle.

14. The system of claim 1, wherein the test case includes testing guidelines for testing of an action taken by the autonomous vehicle in response to predetermined input.

15. A computer-implemented method for test case generation, comprising:
receiving as input at a user interface data relating to (i) an autonomous vehicle, (ii) test objectives for testing of the autonomous vehicle, and (iii) expected results of the testing of the autonomous vehicle;
electronically storing in a database the data input into the user interface and data relating to previously derived cases;
training a language learning model (LLM) unit on the previously derived test cases; and
executing instructions stored in a memory with a processing device in communication with the user interface, the database and the LLM unit to perform operations comprising:
executing the LLM unit to analyze the autonomous vehicle, the test objectives for testing of the autonomous vehicle, and the expected results of the testing of the autonomous vehicle; and
generating with the LLM unit the test case that meets the test objectives for testing of the autonomous vehicle.

16. The computer-implemented method of claim 15, comprising generating with the LLM unit the test case in a form of software executable by a processing device of the autonomous vehicle.

17. The computer-implemented method of claim 15, wherein the expected results include at least one action to be taken by the autonomous vehicle in response to the test objectives.

18. The computer-implemented method of claim 15, wherein the operations comprise generating with the LLM unit the test case that meets the expected results of the testing of the autonomous vehicle.

19. The computer-implemented method of claim 15, wherein the operations comprise generating recommendations for modification or supplementing of the test case to meet the test objectives.

20. The computer-implemented method of claim 15, wherein the operations comprise generating recommendations for safety requirements for inclusion in the test case.
